(19) United States
(12) Patent Application Publication
(10) Pub. No.: US 2009/0109886 A1
(43) Pub. Date: Apr. 30, 2009

(54) WIRELESS COMMUNICATION APPARATUS AND METHOD OF CONTROLLING THE SAME

(75) Inventor: Tetsuya Yamamoto, Kawasaki-shi (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: CANON KABUSHIKI KAISHA, Tokyo (JP)

(21) Appl. No.: 12/252,880

(22) Filed: Oct. 16, 2008

(30) Foreign Application Priority Data
Oct. 30, 2007 (JP) 2007-282353

(51) Int. Cl. G08C 17/00

(52) U.S. Cl. 370/311

(57) ABSTRACT

A wireless communication apparatus in a MIMO communication system which simultaneously transfers different data at the same frequency using a plurality of antennas is provided. The apparatus includes a plurality of receiving units corresponding to the plurality of antennas, respectively. A control unit of the wireless communication apparatus acknowledges a communication protocol command. The control unit sets, in accordance with the acknowledged command, the power mode of the wireless communication apparatus to one of (1) a power saving off mode in which all the receiving units always operate, (2) a dynamic power saving mode in which only one receiving unit operates normally, and upon receiving a transfer request addressed to the apparatus, all the receiving units operate only during a predetermined period, and (3) a static power saving mode in which only one receiving unit always operates, and no MIMO communication is performed.

### BACKGROUND OF THE INVENTION

1. Field of the Invention

The present invention relates to a wireless communication apparatus and a method of controlling the same.

2. Description of the Related Art

In building a system including a plurality of computers, a LAN (Local Area Network) is generally built to share information and effectively use a device such as a printer usable for printing. Such a system recently uses a wireless LAN. A wireless LAN requires no LAN cable and can therefore effectively exploit the convenience of a portable information processing device such as a notebook PC. For these reasons, the wireless LAN will be more popular.

One of the techniques of speeding up the wireless LAN is MIMO (Multi Input Multi Output). In the MIMO, each of the transmitting side and the receiving side uses a plurality of antenna elements and transceivers to form a plurality of logical spatial streams by space division multiplex, thereby increasing the transmission capacity without increasing the frequency band in use. To save power in this technique, MIMO communication is performed only when necessary (Japanese Patent Laid-Open No. 2005-033284), or only minimum and necessary receiving branches are operated (Japanese Patent Laid-Open No. 2006-042075).

There is also used a technique of changing a power saving mode (power supply to the printing unit is OFF) to a normal mode (power supply to the printing unit is ON) when the protocol of a received packet is a reception target protocol (Japanese Patent Laid-Open No. 2007-052544).

However, none of Japanese Patent Laid-Open Nos. 2005-033284, 2006-042075, and 2007-052544 considers the situation in which the MIMO power saving technique is applied.

### SUMMARY OF THE INVENTION

It is an object of the present invention to implement power saving control suitable for MIMO communication.

A wireless communication apparatus capable of performing MIMO (Multi Input Multi Output) communication using a plurality of antennas according to one aspect of the present invention includes a plurality of receiving units corresponding to the plurality of antennas, respectively, an acknowledge unit configured to acknowledge a communication protocol command, and a setting unit configured to set, in accordance with the command acknowledged by the acknowledge unit, a power mode of the wireless communication apparatus to one of a power saving off mode in which all of the plurality of receiving units operate, a dynamic power saving mode in which only one receiving unit operates normally, and upon receiving a transfer request addressed to the apparatus, all of the plurality of receiving units operate only during a predetermined period, and a static power saving mode in which one receiving unit operates.

Further features of the present invention will become apparent from the following description of exemplary embodiments with reference to the attached drawings.

### BRIEF DESCRIPTION OF THE DRAWINGS

FIG. 1 is a view showing the arrangement of a wireless communication system including a wireless communication apparatus according to the first embodiment;

FIG. 2 is a functional block diagram associated with wireless communication and wireless communication settings in the wireless communication apparatus according to the first embodiment;

FIG. 3 is a flowchart for explaining the operation of the wireless communication apparatus according to the first embodiment;

FIG. 4 is a view showing the arrangement of a wireless communication system including a wireless communication apparatus according to the second embodiment; and

FIG. 5 is a flowchart for explaining the operation of the wireless communication apparatus according to the second embodiment.

### DESCRIPTION OF THE EMBODIMENTS

Various exemplary embodiments, features, and aspects of the present invention will be described in detail below with reference to the drawings.

### First Embodiment

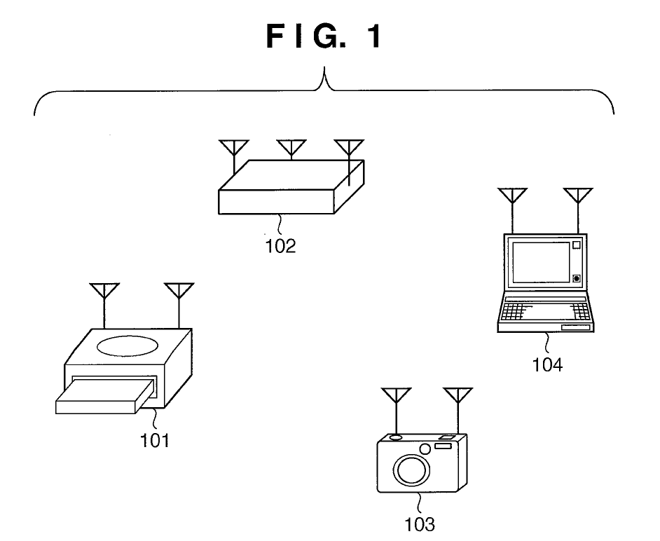

The arrangement of a wireless communication system including a wireless communication apparatus according to this embodiment will be described with reference to FIG. 1.

The wireless communication system is a MIMO communication system and, for example, a MIMO wireless LAN system in an infrastructure mode. Referring to FIG. 1, the present invention is applicable to a slave unit 101 of a wireless LAN. In this case, the slave unit 101 of the wireless LAN is a printer apparatus (image output device). Reference numeral 102 in FIG. 1 denotes a master unit of the wireless LAN. A digital camera (image input device) 103 functions as a slave unit of the wireless LAN. A personal computer 104 functions as a slave unit of the wireless LAN. Each of the master unit and slave units has a plurality of antennas to perform MIMO communication and is designed to simultaneously transmit different data using the same frequency and cause a plurality of receiving units corresponding to the plurality of antennas to receive data.

The MIMO wireless LAN system has three power modes: a power saving off mode, dynamic power saving mode, and static power saving mode. In the power saving off mode, all receiving units always operate. In the dynamic power saving mode, only one receiving unit operates normally, and upon receiving a transfer request addressed to the apparatus, all receiving units operate only during a predetermined period. In the static power saving mode, only one receiving unit always operates. Hence, power saving off mode>dynamic power saving mode>static power saving mode holds for the power consumption. Power saving off mode>dynamic power saving mode>static power saving mode holds for the transfer rate. Power saving off mode=dynamic power saving mode>static power saving mode holds for the data reliability.

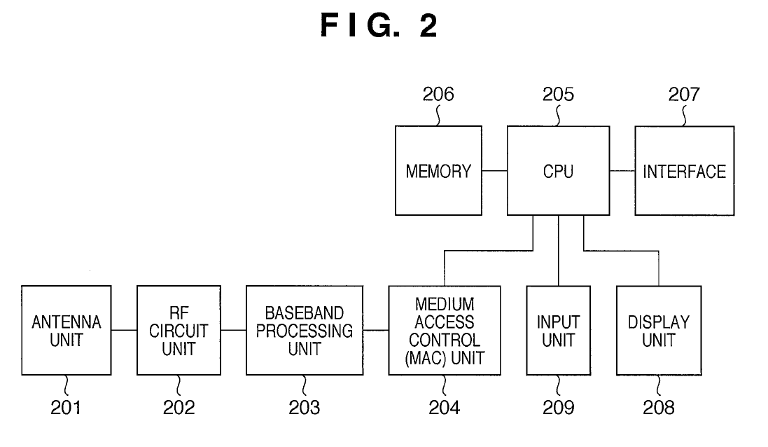

FIG. 2 is a functional block diagram for explaining the functional arrangement for implementing functions associated with wireless communication and wireless communication settings in the slave unit 101 of the wireless LAN.

Upon receiving radio data, an antenna unit 201 captures the radio signal. An RF circuit unit 202 converts the radio signal into a baseband signal. A baseband processing unit 203 converts the baseband signal into a digital signal. A medium access control (MAC) unit 204 converts the digital signal into a predetermined data format and sends it to a CPU 205. In radio data transmission, data flows in a direction reverse to that described above.

The CPU 205 stores the data from the MAC unit 204 in a memory 206 or sends, via an interface 207, the data to an external device or external unit connected to the interface 207. The CPU 205 also receives data from an external device or external unit connected to the interface 207, stores the data in the memory 206 or sends it to the MAC unit 204. The CPU 205 also outputs data stored in the memory 206 to the MAC unit 204 or sends it to an external device or external unit via the interface 207. The CPU 205 also executes various kinds of data processing and outputs the result to a display unit 208 so that the result is displayed. An input unit 209 includes a keyboard and a mouse and is used to input commands and various settings designated by the user.

The wireless communication system according to this embodiment operates in the following way.

First, the user connects the slave units 101, 103, and 104 of the wireless LAN to the master unit 102 of the wireless LAN. This enables communication among the slave units 101, 103, and 104 of the wireless LAN.

After that, the user can transfer an image in the digital camera 103 to the wireless communication apparatus 101 serving as a printer apparatus using PTP (Picture Transfer Protocol) and print it. The user can also cause the wireless communication apparatus 101 serving as a printer apparatus to print data in the personal computer 104.

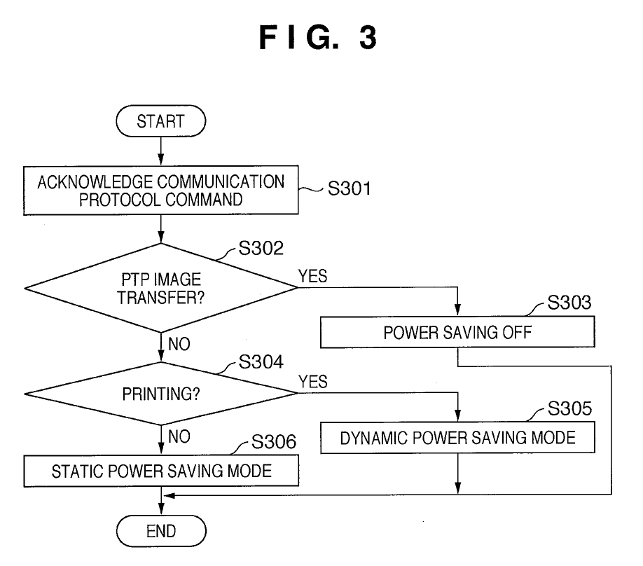

At this time, the wireless communication apparatus 101 sets a power mode in accordance with the flowchart in FIG. 3.

In step S301, the CPU 205 of the wireless communication apparatus 101 acknowledges the communication protocol command. The CPU determines, based on the acknowledged communication protocol command, whether image transfer by PTP is currently progressing (S302). During image transfer by PTP, the CPU determines that data should be sent as fast as possible and sets the power saving off mode (S303). If image transfer by PTP is not progressing, the CPU determines, based on the communication protocol command acknowledged in step S301, whether printing is currently progressing (S304). During printing, the CPU sets the dynamic power saving mode which allows MIMO communication while saving power as much as possible (S305). If printing is not progressing, the CPU determines that high-speed data transfer is unnecessary, and sets the static power saving mode in which no MIMO communication is performed (S306).

The wireless communication apparatus 101 repeatedly executes the series of operations, thereby selecting optimum MIMO power saving for current communication contents.

In the above-described embodiment, the MIMO wireless LAN system in the infrastructure mode has been described. Instead, an ad hoc mode may be used.

### Second Embodiment

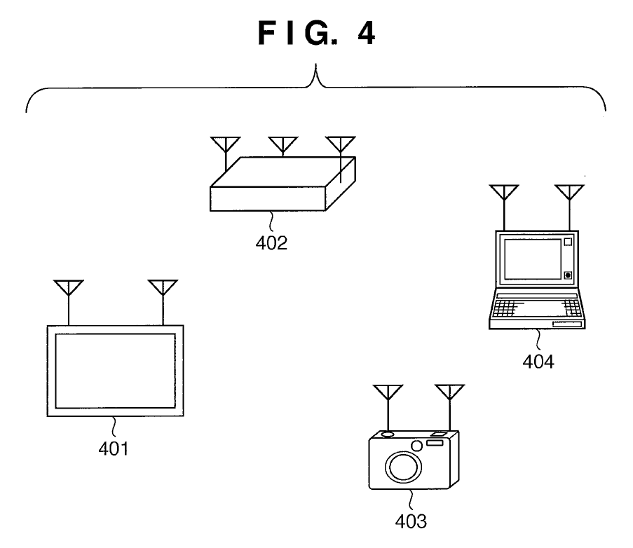

The arrangement of a wireless communication system including a wireless communication apparatus according to the second embodiment of the present invention will be described with reference to FIG. 4.

The wireless communication system is a MIMO wireless LAN system in an infrastructure mode. Referring to FIG. 4, the present invention is applicable to a slave unit 401 of a wireless LAN. In this case, the slave unit 401 of the wireless LAN is a display (image output device). Reference numeral 402 in FIG. 4 denotes a master unit of the wireless LAN. A digital camera (image input device) 403 functions as a slave unit of the wireless LAN. A personal computer 404 functions as a slave unit of the wireless LAN.

The MIMO wireless LAN system has three power modes: a power saving off mode, dynamic power saving mode, and static power saving mode. In the power saving off mode, all receiving units always operate. In the dynamic power saving mode, only one receiving unit operates normally and upon receiving a transfer request addressed to the apparatus, all receiving units operate only during a predetermined period. In the static power saving mode, only one receiving unit always operates.

The functional block diagram for explaining the functional arrangement for implementing functions associated with wireless communication and wireless communication settings in the slave unit 401 of the wireless LAN is the same as that in FIG. 2 described in the first embodiment.

The wireless communication system according to this embodiment operates in the following way.

First, the user connects the slave units 401, 403, and 404 of the wireless LAN to the master unit 402 of the wireless LAN. This enables communication among the slave units 401, 403, and 404 of the wireless LAN.

After that, the user can transfer an image sensed by the digital camera (image input device) 403 to the wireless communication apparatus 401 serving as a display (image output device) using a stream data transfer protocol to display it. The user can also transfer an image data file in the personal computer 404 to the wireless communication apparatus 401 serving as a display (image output device) using a file transfer protocol to display it.

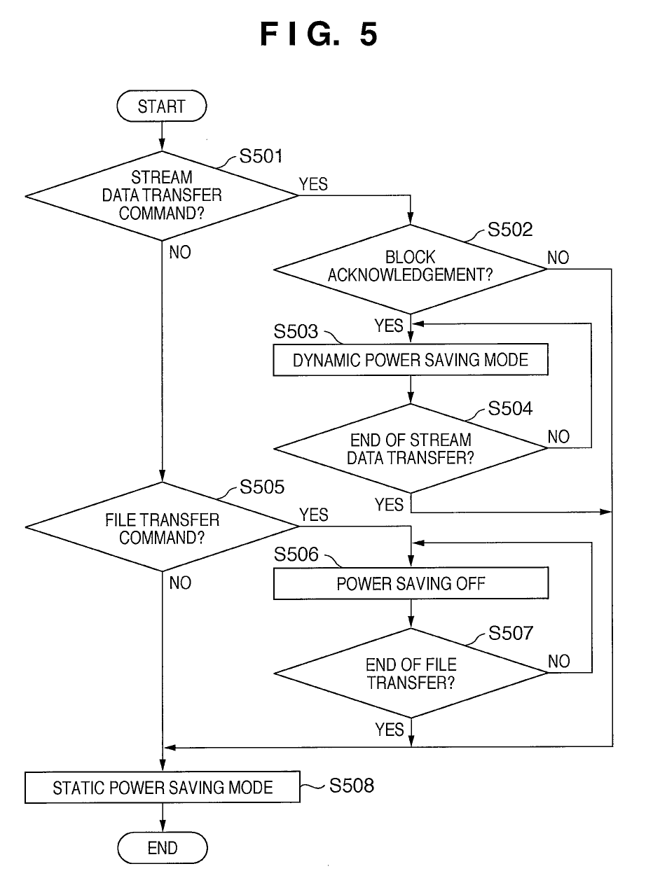

At this time, a CPU 205 of the wireless communication apparatus 401 always acknowledges the communication protocol command. The wireless communication apparatus 401 sets a power mode in accordance with the flowchart in FIG. 5.

First, the CPU acknowledges whether the acknowledged communication protocol command is a stream data transfer command (S501). If it is a stream data transfer command, the CPU further determines whether block acknowledgement, which returns responses to a plurality of data at once, is being executed (S502). Stream data is transferred periodically and therefore requires no high-speed data transfer. However, in block acknowledgement, responses are returned to a plurality of data at once, unlike normal data communication in which a response is returned to each transferred data. For this reason, if a transfer error occurs halfway, the plurality of data transfer processes are wasted. Hence, when block acknowledgement is being executed, the CPU sets the dynamic power saving mode which increases the data reliability while saving power as much as possible (S503). If block acknowledgement is not being executed, the CPU determines that high-speed data transfer is unnecessary, and sets the static power saving mode in which no MIMO communication is performed (S508).

When the dynamic power saving mode is set in step S503, it is maintained until stream data transfer finishes. When stream data transfer has finished, the CPU determines that MIMO communication is unnecessary, and sets the static power saving mode (S508).

If the communication protocol command is not a stream data transfer command in step S501, the CPU determines whether the acknowledged communication protocol command is a file transfer command (S505). If it is a file transfer command, the CPU determines that the data should be sent as fast as possible and sets the power saving off mode (S506).

When the power saving off mode is set in step S506, it is maintained until file transfer finishes. When file transfer has finished, the CPU determines that high-speed data transfer is unnecessary, and sets the static power saving mode in which no MIMO communication is performed (S508).

If the communication protocol command is not a file transfer command in step S505, the CPU determines that high-speed data transfer is unnecessary, and sets the static power saving mode in which no MIMO communication is performed (S508).

The wireless communication apparatus 401 repeatedly executes the series of operations, thereby selecting optimum MIMO power saving for current communication contents.

In this embodiment, the MIMO wireless LAN system in the infrastructure mode has been described. Instead, an ad hoc mode may be used. In step S502, the CPU determines whether block acknowledgement is being executed. Instead, it may be determined whether aggregation for concatenating a plurality of transfer data to one frame is being executed.

### Other Embodiments

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention can be implemented by a computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or script data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a storage medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-282353, filed Oct. 30, 2007, which is hereby incorporated by reference herein in its entirety.

What is claimed is:

1. A wireless communication apparatus capable of performing MIMO (Multi Input Multi Output) communication using a plurality of antennas, comprising:
a plurality of receiving units corresponding to the plurality of antennas, respectively;
an acknowledge unit configured to acknowledge a communication protocol command; and
a setting unit configured to set, in accordance with the command acknowledged by said acknowledge unit, a power mode of the wireless communication apparatus to one of a power saving off mode in which all of said plurality of receiving units operate, a dynamic power saving mode in which only one receiving unit operates normally, and upon receiving a transfer request addressed to the apparatus, all of said plurality of receiving units operate only during a predetermined period, and a static power saving mode in which one receiving unit operates.

2. The apparatus according to claim 1, wherein
the wireless communication apparatus comprises an image output device, and
said setting unit sets the power saving off mode upon determining, based on the command, that image transfer from an image input deice by PTP (Picture Transfer Protocol) is currently progressing.

3. The apparatus according to claim 2, wherein upon determining that image transfer is not progressing, said setting unit further determines, based on the command, whether printing is currently progressing, sets the dynamic power saving mode if printing is progressing, and sets the static power saving mode if printing is not progressing.

4. The apparatus according to claim 1, wherein if the command is a stream data transfer command, said setting unit sets one of the dynamic power saving mode and the static power saving mode depending on whether the wireless communication apparatus is executing block acknowledgement for returning responses to a plurality of data at once.

5. The apparatus according to claim 1, wherein if the command is a stream data transfer command, said setting unit sets one of the dynamic power saving mode and the static power saving mode depending on whether the wireless communication apparatus is executing aggregation for concatenating a plurality of transfer data to one frame.

6. The apparatus according to claim 4, wherein said setting unit sets the static power saving mode when stream data transfer has finished.

7. The apparatus according to claim 1, wherein if the command is a file transfer command, said setting unit sets the power saving off mode.

8. The apparatus according to claim 7, wherein said setting unit sets the static power saving mode when file transfer has finished.

9. A method of controlling a wireless communication apparatus capable of performing MIMO (Multi Input Multi Output) communication using a plurality of antennas, comprising the steps of:
acknowledging a communication protocol command; and
setting, in accordance with the command acknowledged in the acknowledging step, a power mode of a plurality of receiving units corresponding to the plurality of antennas, respectively, to one of a power saving off mode in which all of the plurality of receiving units operate, a dynamic power saving mode in which only one receiving unit operates normally, and upon receiving a transfer request addressed to the apparatus, all of the plurality of receiving units operate only during a predetermined period, and a static power saving mode in which one receiving unit operates.
